(19) United States
(12) Patent Application Publication
(10) Pub. No.: US 2010/0011783 A1
(43) Pub. Date: Jan. 21, 2010

(54) CRYOTRAP AND VACUUM PROCESSING DEVICE WITH CRYOTRAP

(75) Inventors: Kazutoshi Aoki, Minamitsuru-gun (JP); Takahiro Okada, Minamitsuru-gun (JP); Hisayoshi Komai, Minamitsuru-gun (JP); Isao Mochizuki, Fujiyoshida-shi (JP); Tokumitsu Arai, Minamitsuru-gun (JP)

Correspondence Address: FITZPATRICK CELLA HARPER & SCINTO, 1290 Avenue of the Americas, NEW YORK, NY, 10104-3800, US

(73) Assignee: CANON ANELVA TECHNIX CORPORATION, Kawasaki-shi, JP (JP)

(21) Appl. No.: 12/446,675

(22) PCT Filed: May 13, 2008
(86) PCT No.: PCT/JP2008/058782

§ 371 Date: Apr. 22, 2009

(30) Foreign Application Priority Data
May 17, 2007 (JP) 2007-131706
May 17, 2007 (JP) 2007-131707

(51) Int. Cl. F04B 37/08; B01D 8/00; F28F 27/00; F04B 37/14

(52) U.S. Cl. 62/55.5; 165/276

(57) ABSTRACT

A cryotrap which is set in a vacuum vessel, and has an exhaust panel which condenses and exhausts a gas by cooling, and a cooling stage which is connected to a refrigerator and thereby cooled, includes a cooling storage body fixed on a cooling stage while maintaining thermal contact with it, and a mechanism which thermally connects/disconnects the cooling storage body 6 and the exhaust panel. The mechanism which performs thermal connection/disconnection has a movable unit which has a good heat conductivity and can come into contact with and separate from the exhaust panel and the cooling storage body.

### TECHNICAL FIELD

The present invention relates to a cryotrap which performs vacuum exhaust by mainly condensing water vapor using a low temperature, and a vacuum processing apparatus having the cryotrap.

### BACKGROUND ART

A cryotrap performs vacuum exhaust by exhausting the vapor of a substance in a vacuum vessel of a vacuum processing apparatus using condensation of the substance upon cooling an exhaust panel to 200° K. or less. The cryotrap is often used to condense and exhaust water vapors so it is often called a “water trap”.

For example, a cryotrap 101 using a G-M type refrigeration system has a structure shown in FIG. 7.

The cryotrap 101 has a structure in which a refrigerator 102 is directly set on a vacuum processing apparatus 113. The refrigerator 102 is operated upon being supplied with helium gas via a pressure-resistant hose 112 by a compressor 111 installed outside the cryotrap 101 so as to adjust the temperature of a cooling stage 105 to 150 to 50° K.

An exhaust panel is set on the cooling stage 105 while ensuring good heat conductivity, and condenses and exhausts water vapor.

Normally, the inside of the vacuum processing apparatus 113 is roughed out by a roughing vacuum pump 114, and thereafter evacuated to a predetermined pressure by a main exhaust pump 116 (to be also merely referred to as an “exhaust pump” hereinafter) such as a turbo-molecular pump attached to the vacuum processing apparatus 113 via a main valve 115. The cryotrap 101 is used in addition to the main exhaust pump 116 to mainly condense and exhaust water vapor.

In the structure of the cryotrap 101 shown in FIG. 7, an exhaust panel 107 has a large conductance for the inside of the vacuum processing apparatus 113, and hence can be expected to achieve a high exhaust speed. However, to expose the inside of the vacuum processing apparatus 113 to the atmosphere from a vacuum state, it is necessary to take the time to increase the temperature of the exhaust panel 107 to room temperature in order to, for example, prevent the formation of any condensation. In addition, after the operation in the atmosphere, the exhaust panel 107 must be cooled from room temperature to a temperature at which exhaust is possible upon roughing out the inside of the vacuum processing apparatus 113. That is, the exhaust panel returned to room temperature in order to return the vacuum vessel to the atmospheric pressure in, for example, the maintenance of the vacuum processing apparatus or cryotrap must be cooled again to evacuate the vacuum vessel.

An ordinary refrigerator 102 takes a considerable time for this process because its refrigeration capacity is not so high. This makes it difficult to increase the operating rate when, for example, a batch vacuum processing apparatus which frequently repeats the transition between a vacuum state and an atmospheric exposure state is used. For example, it takes 1 to 2 hrs to decrease the exhaust panel from room temperature to about 100° K. upon stopping and restarting the refrigerator 102, depending on the capacity of the refrigerator 102.

In recent years, a cryotrap having the following structure has come to be put on the market. That is, the cryotrap is inserted between the main valve and the main exhaust pump so that the exhaust panel can be maintained at a low temperature by closing the main valve even when the inside of the vacuum processing apparatus is exposed to the atmosphere from a vacuum state.

In a cryotrap having this structure, the exhaust panel can be maintained at a low temperature as long as the main valve is closed even when the inside of the vacuum processing apparatus is exposed to the atmosphere from a vacuum state. However, the exhaust panel can hardly ensure a large conductance for the inside of the vacuum processing apparatus because the main exhaust pump is connected into the vacuum processing apparatus via the main valve. For this reason, the exhaust panel cannot be expected to achieve a high exhaust speed, so its exhaust performance is insufficient when vapor stays behind in a vacuum in large quantities as in the batch vacuum processing apparatus.

A cryopump disclosed in patent reference 1 enumerated below shortens the regeneration processing time while operating the refrigerator by separating a cooling panel (corresponding to the “exhaust panel” according to the present invention) and a cooling device side cylinder in regeneration, and heating the cooling panel. The separation of the cooling panel and the cooling device side cylinder is performed by using a shape memory alloy for a cooling panel attaching part, and externally controlling its temperature.

A cryopump disclosed in patent reference 2 cools the cooling panel by combining the cooling stage (configured to have a good thermal contact property for the refrigerator) and the cooling panel by a mechanism having a variable heat conduction characteristic, and increasing the heat conductivity of the mechanism. To return the cooling panel to room temperature, the heat conductivity of the mechanism is decreased. A helium gas introduction mechanism supplies/exhausts helium gas to/from the mechanism having a variable heat conductivity to activate it by a bellows structure which expands/contracts in synchronism with the supply/exhaust of the gas or by convection of the supplied/exhaust helium gas itself.

A cryopump disclosed in patent reference 3 is provided with a heat conducting bar which can freely abut against, come into contact with, and separate from the surface of the cold panel (exhaust panel). A temperature control source for cooling and heating the heat conducting bar is attached at its edge outside the casing. With this structure, the activation time and regeneration time are shortened.

Patent reference 1: Japanese Patent Laid-Open No. 63-124880
Patent reference 2: Japanese Patent Laid-Open No. 10-122143
Patent reference 3: Japanese Patent Laid-Open No. 61-11474

### DISCLOSURE OF INVENTION

### Problems that the Invention is to Solve

The cryopump according to the prior art disclosed in the above-described patent reference 1 or 2 can shorten the regeneration time because the refrigerator need not be stopped to return the cooling panel to room temperature. However, in cooling the cooling panel to a low temperature in order to exhaust the gas, it cannot be immediately cooled to a predetermined temperature or less even when the refrigerator thermally contacts the cooling panel because the cooling stage has a poor cooling storage function and therefore has a small heat capacity.

Also, this structure cannot form a cooling storage body having a sufficient heat capacity.

In the cryopump disclosed in patent reference 3, the refrigerator must be stopped in returning the cold panel to room temperature, and it takes a lot of trouble to supply liquid nitrogen to the temperature control source.

It is an object of the present invention to provide a cryotrap which can shorten the activation time and regeneration time of the cryotrap while operating a refrigerator by adopting a compact mechanism which allows an exhaust panel and a cooling stage to thermally contact and separate from each other, and a vacuum processing apparatus having the cryotrap.

### Means of Solving the Problems

The above-described problems can be solved by providing a cooling storage body fixed on the cooling stage while maintaining thermal contact with it, and a mechanism which allows the exhaust panel and the cooling storage body to thermally contact and separate from each other.

That is, according to the present invention, there is provided a cryotrap set in a vacuum processing apparatus including an exhaust pump which evacuates an inside of the vacuum processing apparatus to a predetermined pressure, the cryopump including an exhaust panel which condenses and exhausts a gas by cooling the inside of the vacuum processing apparatus, and a cooling stage which is cooled by a refrigerator connected thereto, characterized by comprising:

a cooling storage body which thermally contacts the cooling stage and is held by the cooling stage; and

a connection/disconnection mechanism which thermally connects or disconnects the exhaust panel and the cooling storage body.

Alternatively, according to the present invention, there is provided a vacuum processing apparatus characterized by having the above-described cryotrap.

According to the present invention, a cryotrap has a high exhaust capacity and can shorten the activation time and regeneration time of the cryotrap. Also, a vacuum processing apparatus having the cryotrap according to the present invention can rapidly cool the exhaust panel. This makes it possible to maintain the operating rate even for a batch vacuum processing apparatus which frequently repeats the transition between a vacuum state and an atmospheric exposure state.

### BRIEF DESCRIPTION OF DRAWINGS

The accompanying drawings, which are incorporated in and constitute a part of the specification, illustrate embodiments of the invention, and together with the description of the embodiments, serve to explain the principles of the invention.

FIG. 1 is a view showing the structure of a cryotrap using a G-M type refrigeration system according to the first embodiment of the present invention;

FIG. 2 is a sectional view of the cryotrap according to the first embodiment taken along the line A-A′ in FIG. 1;

FIG. 3A is a view showing a state in which the cryotrap according to the first embodiment is attached to a vacuum processing apparatus, and thermal contact between an exhaust panel and a cooling storage body is maintained;

FIG. 3B is a view showing a state in which the cryotrap according to the first embodiment is attached to the vacuum processing apparatus, and thermal contact between the exhaust panel and the cooling storage body is cut off;

FIG. 4A is a view showing an example in which the cryotrap according to the first embodiment is configured to be partially separable;

FIG. 4B is a view showing a state in which the cryotrap shown in FIG. 4A is partially separated;

FIG. 4C is a view showing a state in which a valve is set in the vacuum processing apparatus;

FIG. 5A is a view showing the structure of a cryotrap according to the second embodiment of the present invention while thermal contact between an exhaust panel and a cooling storage body is maintained;

FIG. 5B is a view showing the structure of the cryotrap according to the second embodiment while thermal contact between the exhaust panel and the cooling storage body is cut off;

FIG. 6 is a view showing the structure of a cryotrap according to the third embodiment of the present invention; and

FIG. 7 is a view showing the structure of a cryotrap using a conventional G-M type refrigeration system.

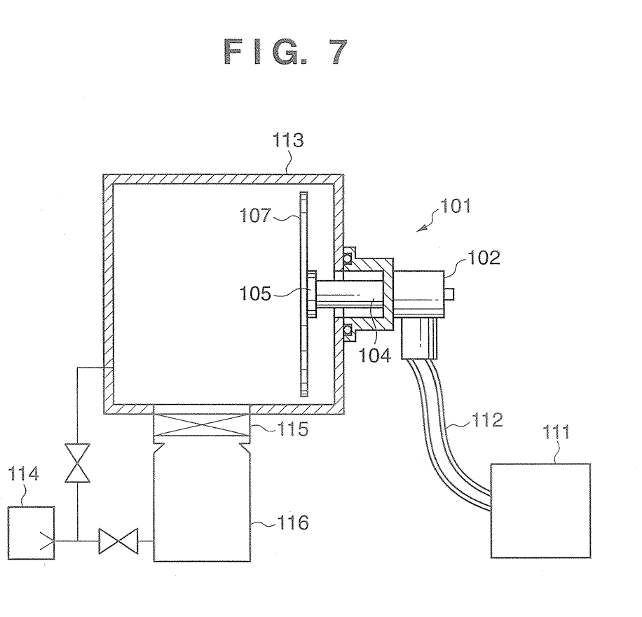

### BEST MODE FOR CARRYING OUT THE INVENTION

Preferred embodiments of the present invention will be exemplified in detail below with reference to the accompanying drawings. Note that constituent components set forth in these embodiments are merely examples, and the technical scope of the present invention is defined by the scope of claims and is not limited by the following individual embodiments.

A vacuum exhaust apparatus (cryotrap) is the same as in the prior arts in that it performs vacuum exhaust by exhausting the vapor of a substance in a vacuum vessel of, for example, a vacuum processing apparatus using condensation of the substance upon cooling an exhaust panel (cooling panel) to 200° K. or less. Although a description will be given assuming that the vapor is water vapor, the vapor may be of another substance.

In the cryotrap, an exhaust panel is set on the outer surface of a vacuum vessel newly set in the cryotrap while ensuring a good heat conductivity. The vacuum vessel holds a cooling storage body having a heat capacity twice or more that of the exhaust panel, and a cooling unit of a refrigeration system. The exhaust panel and the cooling storage body have a structure in which they can be thermally connected/disconnected, that is, a structure in which their heat conduction and heat insulation can be switched.

The refrigeration system always cools the cooling storage body. The cooling storage body can be freely designed to have a large heat capacity.

The cooling storage body has a heat capacity at which when the cooling storage body cooled thermally contacts the exhaust panel at room temperature, the exhaust panel is cooled to a temperature at which the water vapor pressure becomes lower than the target vacuum room pressure. The cooling storage body and exhaust panel are fixed.

The cryotrap has a structure in which if the exhaust panel is heated to room temperature, it is thermally disconnected from the cooling storage body, and if the exhaust panel is cooled, it is thermally connected with the cooling storage body. For this reason, although the exhaust panel can be set in the vacuum processing apparatus to ensure a large conductance, it can be cooled rapidly. This makes it possible to maintain a high operating rate even for a batch vacuum processing apparatus which repeats the transition between a vacuum state and an atmospheric exposure state.

To attain this structure, a cooling storage body specialized for cooling storage, and a movable unit that is specialized for thermal switching and is excellent in heat conductivity are adopted and assigned separate roles.

The movable unit need only have a small heat resistance and be excellent in thermal contact property, and it preferably has a small heat capacitance. Hence, the movable unit can be compact and is less likely to break down.

When the cooling storage body is a movable unit and a deformable member such as a bellows is inserted between the cooling storage body and the refrigerator, their thermal contact may be limited. This may decrease the cooling storage efficiency of the cooling storage body. In this case, the cooling efficiency of the exhaust panel may also deteriorate. According to the present invention, the cooling storage body and the refrigerator maintain sufficient thermal contact, and they have excellent durability.

The exhaust panel can be returned to room temperature without stopping the refrigerator. After that, the exhaust panel can be cooled from room temperature to a predetermined temperature or less in order to perform vacuum exhaust, before the system reaches a steady state upon bringing the cooling storage body into thermal contact with the exhaust panel. This makes it possible to greatly shorten the apparatus stop time, thus increasing the operating rate.

A mechanism which allows thermal connection/disconnection (to be also referred to as a “connection/disconnection mechanism” hereinafter) adopts a means defined in any one of (1) to (3) below.

(1) A connection/disconnection mechanism is formed from a movable unit which has a good heat conduction characteristic (to be also referred to as a “good heat conductivity” hereinafter) and can thermally contact and separate from both the cooling storage body and exhaust panel fixed in position. The movable unit can be moved by (i) mechanical manipulation or (ii) deformation by a thermal deforming means which uses a shape memory alloy. The movement of the movable unit controls contact and separation between the cooling storage body and the exhaust panel.

(2) A connection/disconnection mechanism is formed from a deformable member which has a good heat conduction characteristic, is fixed to one of the cooling storage body and exhaust panel fixed in position, and is arranged to be thermally contactable with and separable from the other one. The deformable member has, for example, a bellows and contact body having a good heat conduction characteristic. The deformable member can be activated by (i) introducing a gas into the bellows of the deformable member or exhausting a gas from inside the bellows, or (ii) deforming the deformable member by a thermal deforming means which uses a shape memory alloy. The activation of the deformable member controls contact and separation between the cooling storage body and the exhaust panel.

(3) A connection/disconnection mechanism is formed so as to change the heat transfer characteristic between the cooling storage body and the exhaust panel using gaseous convection generated by introducing a gas into a space formed between the cooling storage body and the exhaust panel fixed in position or exhausting a gas from the space.

In the cryotrap, if the exhaust panel is heated, the mechanism which thermally connects/disconnects the exhaust panel and cooling storage body can maintain the cooling storage body at a low temperature while thermal contact between the exhaust panel and the cooling storage body is cut off. If the exhaust panel is cooled, the mechanism can restore thermal contact between the exhaust panel and the cooling storage body.

A design example of the cooling storage body will be shown next.

The cooling storage body cooled (about 50° K.) is brought into thermal contact with the exhaust panel at room temperature (about 280° K.). Note that the cooling storage body has a heat capacity 3.8 times or more that of the exhaust panel so as to decrease the temperature of the exhaust panel to about 120° K. or less (a temperature at which the water vapor pressure becomes one-hundredth or less (10⁻⁹ Pa or less) of a pressure (10⁻⁷ Pa) that an ordinary sputtering device can reach).

As another example, the cooling storage body cooled (about 50° K.) is brought into thermal contact with the exhaust panel at room temperature (about 280° K.). Note that the cooling storage body has a heat capacity 2.0 times or more that of the exhaust panel so as to decrease the temperature of the exhaust panel to about 150° K. or less (a temperature at which the water vapor pressure becomes one-tenth or less, that is, 10⁻⁵ Pa or less of a pressure (10⁻⁴ Pa) that an ordinary deposition device can reach).

### First Embodiment

The structure and operation of a cryotrap according to the first embodiment of the present invention will be described below with reference to the accompanying drawings. The first embodiment is an example corresponding to (i) in (1) of the above-described mechanism which allows thermal connection/disconnection (connection/disconnection mechanism).

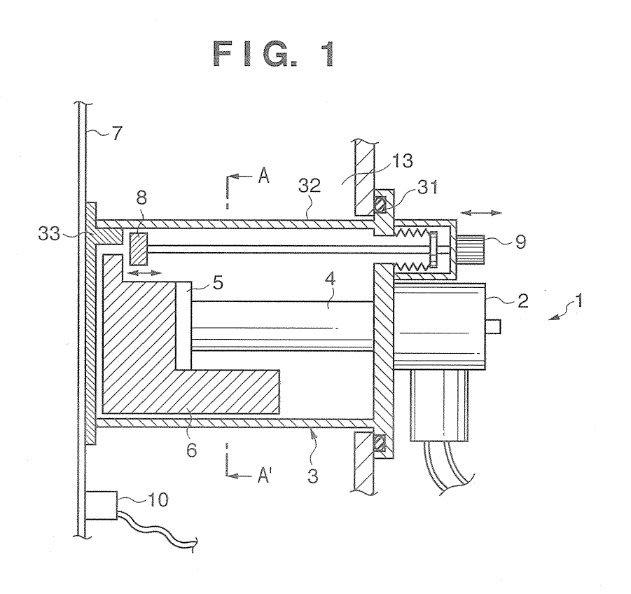

FIG. 1 is a view showing the structure of a cryotrap 1 using a G-M type refrigeration system according to this embodiment.

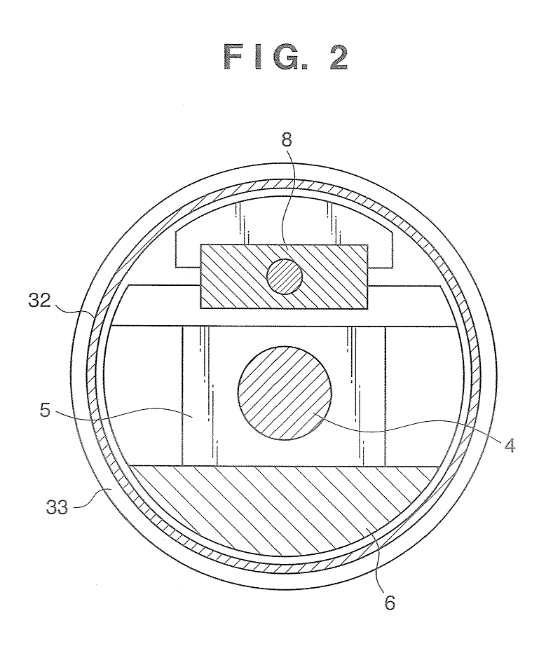

FIG. 2 is a sectional view of the cryotrap according to this embodiment taken along the line A-A′ in FIG. 1.

A vacuum vessel 3 is newly set in the cryotrap 1. The cryotrap 1 is attached to a vacuum processing apparatus 13 via the vacuum vessel 3 extending in the vacuum processing apparatus 13. In the cryotrap 1, a cooling stage 5 connected to a refrigerator 2 via a cylinder 4 is cooled by the refrigerator 2.

The G-M type refrigeration system can be substituted by another refrigeration system such as a pulse tube refrigeration system.

The vacuum vessel 3 has a cylindrical shape and is used in a vacuum (several pascals). For this reason, an exhaust port and exhaust device (neither of which are shown) are provided to the vacuum vessel 3 to evacuate the inside of the cylinder and then seal it by closing a valve. An adsorbent (non-evaporative getter material) may be encapsulated in the vacuum vessel 3. A conventional cryotrap as described above is used in a vacuum room of a vacuum processing apparatus the vacuum breaking of which is rarely performed. In contrast, because the present invention assumes a batch vacuum processing apparatus used by frequently performing vacuum breaking of its vacuum room, it is necessary to maintain a cooling unit including the cooling stage 5 in a vacuum.

The vacuum vessel 3 is formed from a member 31, side portion 32, and bottom portion 33 which cover the opening of the vacuum processing apparatus 13.

An exhaust panel 7 attached on the bottom surface of the vacuum vessel 3, that is, the surface of the bottom portion 33, which exposes into the vacuum processing apparatus 13, is attached to the cryotrap 1 while ensuring a good heat conductivity. The bottom portion 33 itself is made of a material having a good heat conductivity as well. The exhaust panel 7 and bottom portion 33 are made of, for example, copper (Cu).

The side portion 32 of the vacuum vessel 3 is made of a material, that has a relatively low heat conductivity, such as stainless steel (SUS) to have a small sectional area in order to suppress heat from being transferred to the exhaust panel 7 from an environment at room temperature when the exhaust panel 7 is set at a low temperature.

A cooling storage body 6 having a heat capacity twice or more that of the exhaust panel 7, and the cooling stage 5 of the refrigerator 2 are accommodated in the vacuum vessel 3 and are always maintained in a vacuum to cut off heat transfer with the vacuum vessel 3. The cooling storage body 6 is connected outside the cooling stage 5 while ensuring a good heat conductivity and thereby cooled so as to be always maintained at a low temperature. The cooling storage body 6 can be designed to have a large heat capacity and is made of, for example, copper (Cu). The cooling storage body 6 has a partial cylindrical outer shape in the cylindrical vacuum vessel 3, as shown in FIG. 2.

A heat transfer body 8 which can be moved from outside a vacuum environment and is made of a material having a high heat conductivity is accommodated in the vacuum vessel 3, thereby forming a thermal switch structure which can switch between heat transfer and heat insulation between the bottom portion 33 of the vacuum vessel 3 and the cooling storage body 6. The thermal switch is often made of, for example, copper (Cu) but can be made of indium or graphite in order to facilitate thermal contact. The thermal switch shown in FIG. 1 has a structure in which the heat transfer body 8 as a movable unit connected, via a bar, to a knob 9 outside the member 31 of the vacuum vessel 3 is moved by the knob 9 so that the bottom portion 33 and cooling storage body 6 come into contact with and separate from each other.

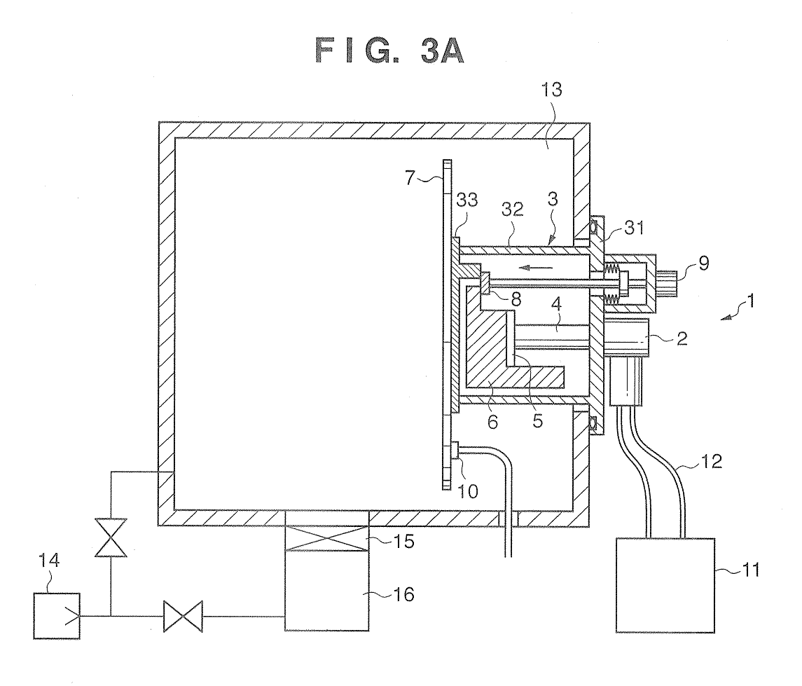

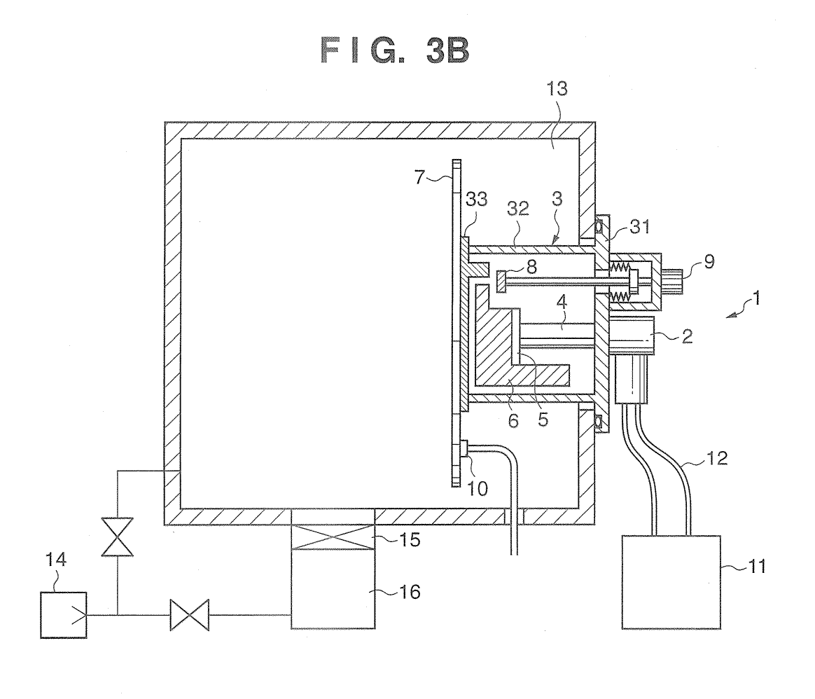

FIG. 3A is a view showing a state in which the cryotrap according to this embodiment is attached to the vacuum processing apparatus, and thermal contact between the exhaust panel and the cooling storage body is maintained.

Thermal contact between the exhaust panel 7 and the cooling storage body 6 is performed by bringing the heat transfer body 8 into contact with the bottom portion 33 and cooling storage body 6 by manipulating the knob 9.

As in the prior arts, the inside of the vacuum processing apparatus 13 is roughed out by a roughing vacuum pump 14, and thereafter evacuated to a predetermined pressure by a main exhaust pump 16 such as a turbo-molecular pump attached to the vacuum processing apparatus 13 via a main valve 15a. The cryotrap 1 is used in addition to the main exhaust pump 16 to mainly condense and exhaust water vapor. The refrigerator 2 is operated upon being supplied with helium gas via a pressure-resistant hose 12 by a compressor 11 installed outside the cryotrap 1 so as to adjust the temperature of the cooling stage 5 to 150 to 50° K.

FIG. 3B is a view showing a state in which thermal contact between the exhaust panel and the cooling storage body is cut off.

Thermal contact between the exhaust panel 7 and the cooling storage body 6 is cut off by separating the heat transfer body 8 from the bottom portion 33 and cooling storage body 6 by manipulating the knob 9.

In this embodiment, the exhaust panel 7 is set in the vacuum processing apparatus 13. In exposing the inside of the vacuum processing apparatus 13 to the atmosphere, the bottom portion 33 of the vacuum vessel 3 and the cooling storage body 6 are thermally insulated by operating the heat transfer body 8, and thereafter the temperature of the exhaust panel 7 is increased. This obviates the need to increase the temperatures of the cooling storage body 6 and the cooling stage 5 of the refrigerator 2. To shorten the time to increase the temperature of the exhaust panel 7, it is effective to set a heater 10 on the exhaust panel 7 or the bottom portion 33 of the vacuum vessel 3.

After the operation in the vacuum processing apparatus 13 in the atmosphere and the like are completed, the inside of the vacuum processing apparatus 13 is roughed out again, as shown in FIG. 3A, to restore heat conduction between the bottom portion 33 and the cooling storage body 6 by operating the exhaust panel 7. The exhaust panel 7 is rapidly cooled in this way, which makes it possible to restore its water vapor condensation/exhaust capacity in a short period of time.

The larger the differences in heat capacity between the cooling storage body 6 and the exhaust panel 7 and the bottom portion 33 of the vacuum vessel 3, and the lower the temperature of the cooling storage body 6 before heat conduction restoration, the better the cooling effect obtained becomes.

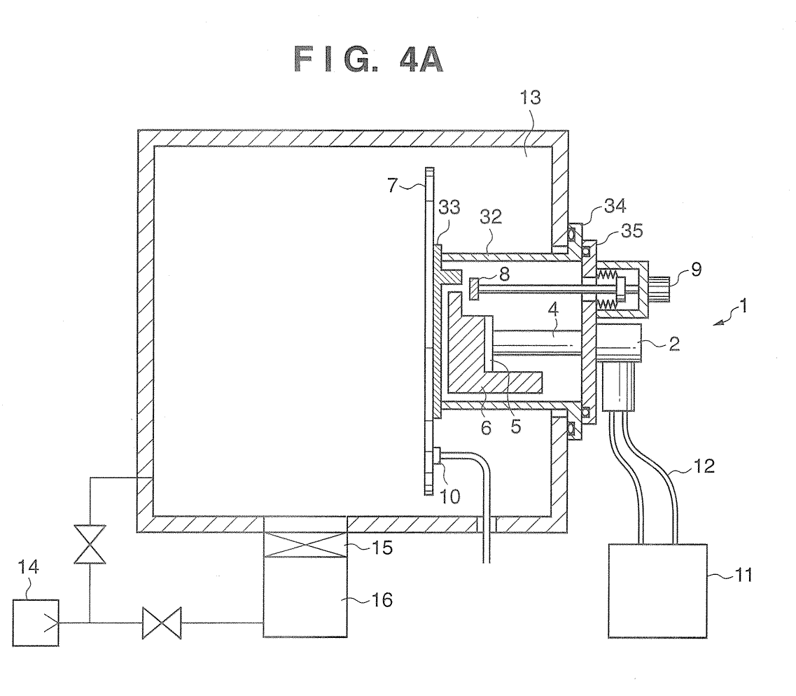

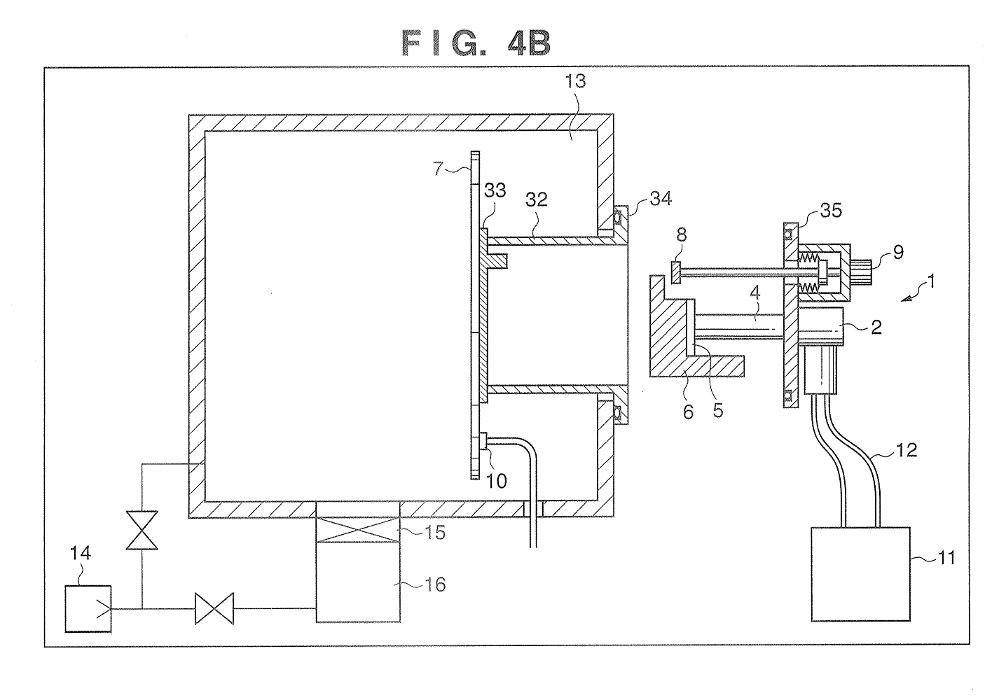

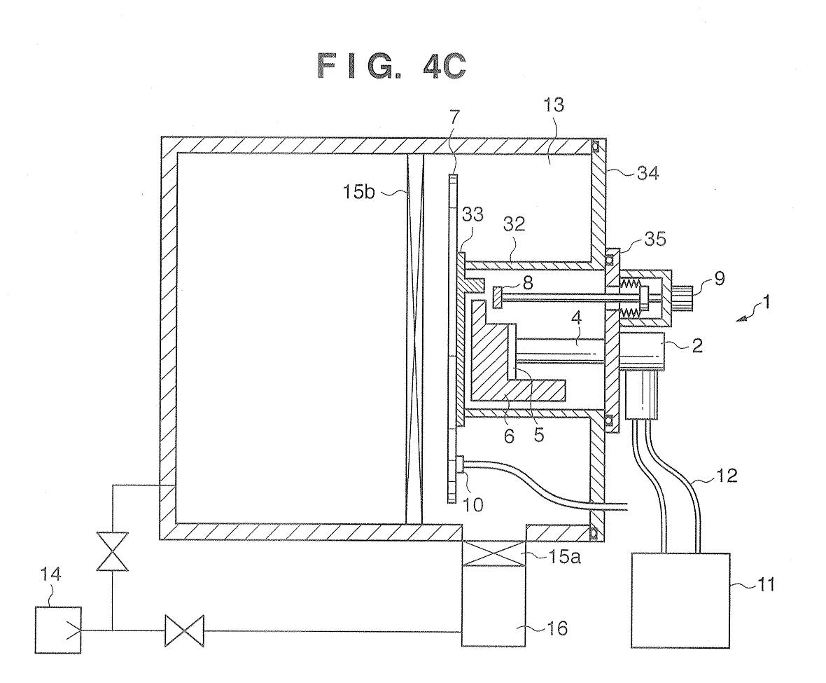

FIG. 4A is a view showing an example in which the cryotrap according to this embodiment is configured to be partially separable.

In this embodiment, the member of the vacuum vessel 3 is divided into two parts 34 and 35, and their outer portions are configured to be separable from each other.

With this structure, constituent components supported by the member 35 can be detached while the exhaust panel 7 and the member 34, side portion 32, and bottom portion 33 of the vacuum vessel 3 are kept attached to the vacuum processing apparatus 13. This detachable structure facilitates maintenance such as cleaning. The maintenance must be performed once or twice a year, in which a sealing portion, bearing, valve, and the like in the refrigerator are replaced by new ones.

FIG. 4B is a view showing a state in which the cryotrap shown in FIG. 4A is partially separated.

One part 34 of the member is kept fixed to the vacuum processing apparatus 13, while the other part 35 of the member is detachable from one part 34 of the member.

FIG. 4C is a view showing a state in which a valve which divides the inside of the vacuum processing apparatus 13 into two is set in it. A valve 15b can divide the inside of the vacuum processing apparatus 13 into an internal space (first space) which is maintained in a vacuum state and in which a processing object is processed, and an internal space (second space) exposed to the atmosphere by detaching the cryopump 1. That is, FIG. 4C shows a structure in which the inside of the vacuum processing apparatus 13 is partitioned by the valve 15b, and the cryotrap 1 including the exhaust panel 7 is accommodated in one internal space (second space) of the vacuum processing apparatus 13. Setting the valve 15b in the vacuum processing apparatus 13 makes it possible to detach the cryotrap 1 while maintaining, in a vacuum, an internal space in which the cryotrap 1 is not set (first space). This makes it possible to shorten the time to evacuate the second space after setting the cryotrap 1. In this case, a pressure control valve for connecting the first space and the second space may be set in the vacuum processing apparatus 13.

Still better, the cryotrap 1 can be detached from the member 34 of the vacuum processing apparatus 13 even while the cooling storage body 6 is maintained at a sufficiently low temperature. Hence, after the exhaust panel 7 is replaced by a new one, it can be cooled rapidly.

The cryotrap 1 may have a structure in which the exhaust panel 7 and cooling stage 5 of the cryotrap 1 are in direct contact with each other.

In this case, the cryotrap 1 in which the exhaust panel 7 and cooling stage 5 are in direct contact with each other may be inserted between the main valve 15a and the main exhaust pump 16. Note that the main valve 15a functions similarly to the valve 15b, so the valve 15b may be omitted. Although an example corresponding to (i) in (1) of the above-described mechanism which allows thermal connection/disconnection has been explained, the heat transfer body 8 as a movable unit as in (ii) may be moved by a thermal means using a shape memory alloy. That is, the heat transfer body 8 can be moved by attaching a shape memory alloy to the heat transfer body 8, and changing the temperature of the shape memory alloy from outside the vacuum vessel 3 to deform it.

According to this embodiment, the cryotrap can be given a high exhaust capacity, and the exhaust panel can be cooled rapidly. This makes it possible to maintain a high operating rate even for a batch vacuum processing apparatus which frequently repeats the transition between a vacuum state and an atmospheric exposure state.

### Second Embodiment

The second embodiment is an example corresponding to (i) in (2) of the above-described mechanism which allows thermal connection/disconnection (connection/disconnection mechanism).

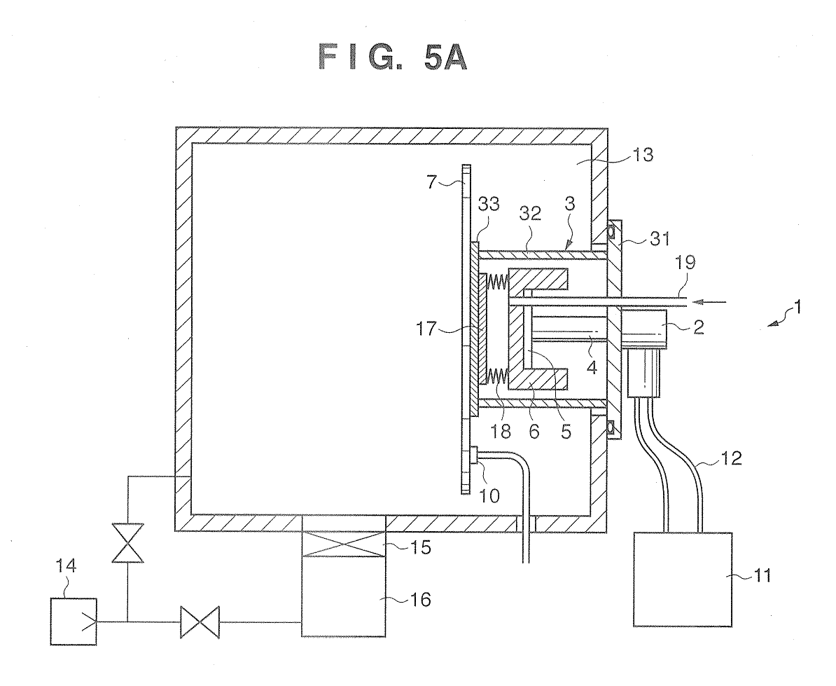

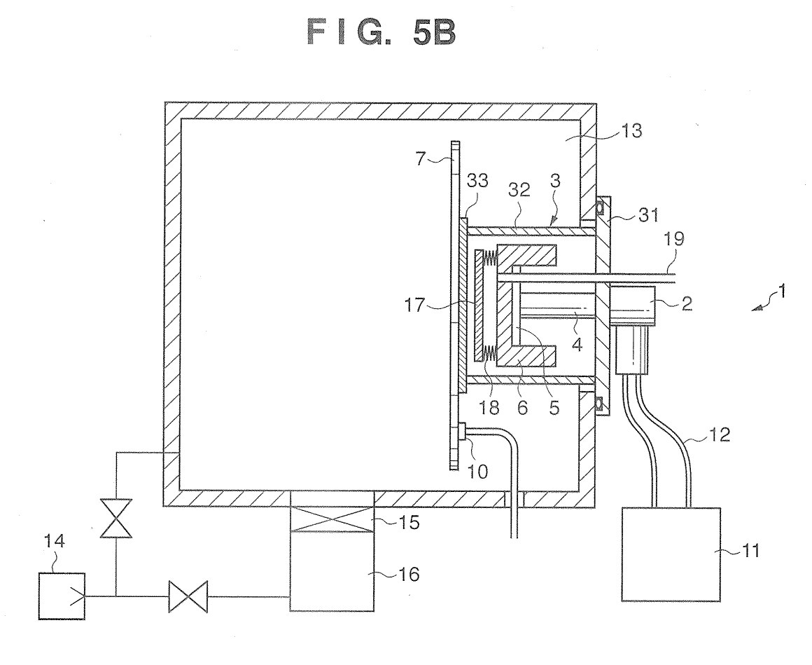

FIG. 5A is a view showing the structure of a cryotrap according to this embodiment while thermal contact between an exhaust panel and a cooling storage body is maintained.

A deformable member which has a good heat conductivity, is fixed to one of a cooling storage body 6 and an exhaust panel 7, and thermally contacts and separates from the other one is inserted between the cooling storage body 6 and the exhaust panel 7. The deformable member includes a bellows 18 or the like and a contact body 17, which have good heat conductivity. The deformable member is brought into contact with both the cooling storage body 6 and the exhaust panel 7 by introducing a gas into the bellows 18 by a gas inlet pipe 19 for introducing a gas into the bellows 18 or exhausting a gas from inside the bellows 18.

FIG. 5B is a view showing a state in which thermal contact between the exhaust panel 7 and the cooling storage body 6 is cut off.

Unless a gas is introduced into the bellows 18, thermal contact between the cooling storage body 6 and the exhaust panel 7 is cut off.

As in (ii) of (2), the deformable member may be deformed by a thermal means using a shape memory alloy.

The example in which the cryopump is configured to be partially separable, shown in FIGS. 4A and 4B in the first embodiment, is also applicable in this embodiment.

According to this embodiment, the cryotrap is given a high exhaust capacity, and the exhaust panel can be cooled rapidly. This makes it possible to maintain a high operating rate even for a batch vacuum processing apparatus which frequently repeats the transition between a vacuum state and an atmospheric exposure state.

### Third Embodiment

The third embodiment is an example corresponding to (3) of the above-described mechanism which allows thermal connection/disconnection (connection/disconnection mechanism)

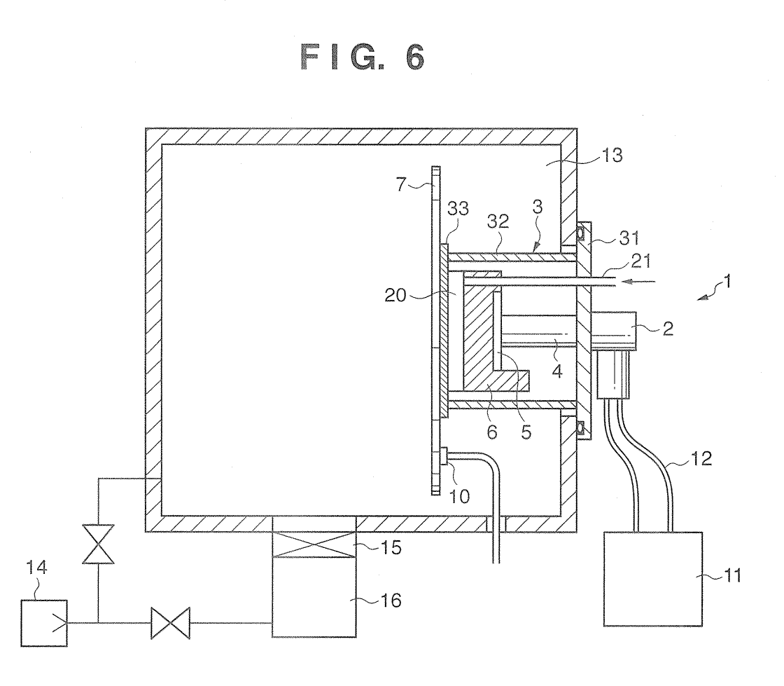

FIG. 6 is a view showing the structure of a cryotrap according to the third embodiment of the present invention.

In the third embodiment, neither the movable unit nor deformable member as used in the first and second embodiments are used. The cryotrap is configured to change the heat transfer characteristic between a cooling storage body 6 and an exhaust panel 7 using gaseous convection generated by introducing a gas, which has a high heat conductivity, such as helium gas into a vacant room 20 between the cooling storage body 6 and the exhaust panel 7 or exhausting a gas from inside the vacant room 20 by a gas inlet pipe 21. According to this embodiment, the cryotrap can be given a high exhaust capacity, and the exhaust panel can be cooled rapidly. This makes it possible to maintain a high operating rate even for a batch vacuum processing apparatus which frequently repeats the transition between a vacuum state and an atmospheric exposure state.

Although preferred embodiments of the present invention have been explained above with reference to the accompanying drawings, the present invention is not limited to these embodiments, and can be changed into various forms within the technical scope defined by the scope of claims.

The present invention is not limited to the above-described embodiments, and various types of change and modification can be made without departing from the spirit and scope of the present invention. Accordingly, the following claims are appended to disclose the scope of the present invention.

This application claims the benefit of Japanese Patent Application No. 2007-131706 filed May 17, 2007, Japanese Patent Application No. 2007-131707 filed May 17, 2007, which are hereby incorporated by reference herein in their entirety.

1. A cryotrap set in a vacuum processing apparatus including an exhaust pump which evacuates an inside of the vacuum processing apparatus to a predetermined pressure, the cryopump including an exhaust panel which condenses and exhausts a gas by cooling the inside of the vacuum processing apparatus, and a cooling stage which is cooled by a refrigerator connected thereto, comprising:
a cooling storage body which thermally contacts the cooling stage and is held by the cooling stage; and
a connection and disconnection mechanism which thermally connects or disconnects the exhaust panel and said cooling storage body.

2. The cryotrap according to claim 1, wherein said connection and disconnection mechanism is configured to include a movable unit which has a good heat conductivity and can come into contact with and separate from both the exhaust panel and said cooling storage body.

3.-4. (canceled)

5. The cryotrap according to claim 1, wherein said connection and disconnection mechanism is made of a deformable member which has a good heat conductivity, is fixed to one of the exhaust panel and said cooling storage body, and is arranged to be thermally contactable with and separable from the other one.

6.-7. (canceled)

8. The cryotrap according to claim 1, wherein said connection and disconnection mechanism is configured to change a heat transfer characteristic between said cooling storage body and the exhaust panel by gaseous convection generated by introducing a gas into a space formed between the exhaust panel and said cooling storage body or exhausting a gas from the space.

9. The cryotrap according to claim 1, wherein a heater is set on the exhaust panel to rapidly heat the exhaust panel.

10. The cryotrap according to claim 1, wherein said cooling storage body has a heat capacity not less than 2.0 times a heat capacity of the exhaust panel.

11. (canceled)

12. The cryotrap according to claim 1, wherein the exhaust panel is attached on an outer surface of a vacuum vessel set in the vacuum processing apparatus, and said cooling storage body and the cooling stage are accommodated in the vacuum vessel.

13. (canceled)

14. The cryotrap according to claim 1, further comprising a valve which divides the inside of the vacuum processing apparatus into a first space in which a vacuum state is maintained, and a second space exposed to the atmosphere by detaching a member,
wherein said cooling storage body and the cooling stage accommodated in the second space via the member can be separated from the second space by detaching the member.

15. (canceled)

16. A vacuum processing apparatus comprising the cryotrap of claim 1.

17. The vacuum processing apparatus according to claim 16, further comprising a valve which connects the exhaust pump to the vacuum processing apparatus,
wherein said cryotrap is inserted between said valve and the exhaust pump.
